(19) United States
(12) Patent Application Publication
(10) Pub. No.: US 2016/0025152 A1
(43) Pub. Date: Jan. 28, 2016

(54) CLUTCH FOR NON-ENGINE POWERED VEHICLE DRIVE WHEEL

(71) Applicant: Borealis Technical Limited, North Plains, OR (US)

(72) Inventors: James Klassen, Langley (CA); Jonathan S. Edelson, Portland, OR (US); Scott Perkins, Kent, OR (US); Joseph J. Cox, Modiin (IL)

(21) Appl. No.: 14/337,227

(22) Filed: Jul. 22, 2014

(51) Int. Cl. F16D 11/14; B64C 25/40; B60B 27/00; F16D 27/09

(52) U.S. Cl. CPC F16D 11/14; F16D 27/09; B64C 25/405; B60B 27/0021

(57) ABSTRACT

A clutch designed to effectively transfer torque between wheel drive system components in a vehicle drive wheel drive system to move the vehicle on a ground surface is provided. The wheel drive system components may include a non-engine drive means and a roller traction drive in torque transmission contact with the clutch and with the vehicle drive wheel. The clutch includes complementarily configured clutch components designed to mesh into engaging contact when activated by electromagnetic or other external engagement actuation means to transfer torque through an interface to a vehicle wheel. Drag and friction produced by activation of adjacent rotating patterned clutch elements amplifies axial forces to cause clutch elements to mesh into locking engagement to control transfer of torque between a non-engine drive means and a roller traction drive system to drive an aircraft landing gear wheel or other vehicle wheel.

### TECHNICAL FIELD

The present invention relates generally to drive wheel clutches and clutch systems and specifically to a clutch designed for a non-engine powered drive wheel with a roller traction drive actuation system used to move an aircraft or other vehicles during ground travel.

### BACKGROUND OF THE INVENTION

Most vehicle drive systems include clutches that may be engaged and disengaged to actuate drive system components and control torque of these components as the vehicle is driven by the drive system. Providing a clutch able to effectively transfer torque in a vehicle drive system, particularly in a drive system powered by a non-engine drive means that is contained within the dimensions of a vehicle wheel, has presented challenges.

A wide range of different types of clutches suitable for transferring torque is known in the art. For example, in U.S. Pat. No. 8,333,272, Wheals et al disclose a dual clutch for automotive applications that includes a driving plate having a top hat type configuration with opposing engagement surfaces that engage axially aligned friction plates that are held in engagement with spring elements. In U.S. Patent Application Publication No. US2004/0256192, Hill et al describe an electromagnetic friction clutch with at least two components mounted to be rotatable relative to one another that may be pressed against each other by magnetic force. A magnetic friction clutch with friction discs that is stated to be capable of relatively high torque transfer is described by Shchokin et al in U.S. Patent Application Publication No. US2008/0142327. In U.S. Pat. Nos. 4,175,650 and 4,293,060, Miller discloses electromagnetic friction clutches that, respectively, prevent loss of torque between driven and driving means as friction material wears and provide a torque overload release arrangement. It is not suggested that any of the clutch arrangements described in the foregoing patents and published applications could be modified to effectively transfer torque in a vehicle drive wheel drive system located within the dimensions of a vehicle wheel that includes a non-engine drive means and a roller traction drive system operatively associated in torque transfer relationship with the drive means and a clutch.

Providing an electric motor within an aircraft nose wheel to drive an aircraft nose wheel and move the aircraft on the ground is described in U.S. Pat. No. 7,445,178 by McCoskey et al. This arrangement includes a dual cone activated mechanism that functions in combination with gearing to move a clutch laterally toward a rotor in the motor. It is not suggested that this clutch design could be adapted to transfer torque between a non-engine drive means and a roller traction drive system or other drive system to the aircraft nose wheel or to any other aircraft or vehicle wheel.

A need exists, therefore, for an effective clutch design that is capable of controlling the transfer of torque and transferring torque between a non-engine drive means, a roller traction drive or other drive system in torque transfer contact with the non-engine drive means, and a wheel in a vehicle wheel drive system contained within the dimensions of a vehicle wheel that operates to drive the vehicle at a desired ground travel speed and/or torque. A need also exists for an effective clutch design capable of controlling torque transfer and transferring torque between a non-engine drive means and a roller traction drive or other drive system and a wheel in an aircraft wheel drive system contained within the dimensions of an aircraft landing gear wheel that operates to drive an aircraft wheel and the aircraft at a desired taxi speed.

### SUMMARY OF THE INVENTION

It is a primary object of the present invention therefore, to provide an effective clutch design that is capable of controlling torque transfer and transferring torque between a non-engine drive means, a drive system, and a wheel in a vehicle wheel drive system contained within the dimensions of a vehicle wheel that operates to drive the vehicle at a desired ground travel speed and/or torque.

It is another object of the present invention to provide an effective clutch design capable of controlling torque transfer and transferring torque between a non-engine drive means, a drive system, and a wheel in an aircraft wheel drive system contained within the dimensions of an aircraft landing gear wheel that operates to drive an aircraft wheel and the aircraft at a desired taxi speed.

It is an additional object of the present invention to provide a clutch configured with engaging surfaces having a geometry that, upon actuation of the clutch, causes the amplification of forces created as a result of the geometry of the engaging surfaces to transmit torque between a mechanical input and a mechanical output.

It is a further object of the present invention to provide a clutch for a vehicle drive wheel with a wheel drive system capable of driving the vehicle at a desired torque and/or speed by the transfer of torque between an electric drive motor, a roller traction drive system, and a vehicle wheel, wherein clutch components are configured to transmit torque to the vehicle wheel by a combination of circumferential and axial forces in response to external actuation.

It is a further object of the present invention to provide an electromagnetically activated clutch with a number of complementarily configured components that meshingly engage upon activation to produce sufficient circumferential and axial force to transfer torque to a vehicle wheel from a drive system.

It is yet an additional object of the present invention to provide a clutch useful for transferring torque in a drive wheel, wherein the geometry of meshing components of complementarily configured clutch elements may be selected to amplify the force required after clutch actuation to transmit a desired torque.

It is yet another object of the present invention to provide an electromagnetically activated clutch in a vehicle drive wheel drive system that includes an electric drive means and a roller traction drive system coupled to the clutch with clutch components configured to facilitate torque transfer from the electric drive means to a vehicle wheel.

It is yet an additional object of the present invention to provide a method for controlling torque transfer in a vehicle wheel drive system that includes a non-engine drive means, a roller traction drive system, and a clutch designed to transfer torque between these wheel drive system components and a vehicle drive wheel to move the vehicle on a ground surface at a desired speed and/or torque.

It is yet a further object of the present invention to provide a method for controlling torque transfer in an aircraft landing gear wheel drive system that includes a non-engine drive means, a roller traction drive system, and a clutch designed to transfer torque between these wheel drive system components and an aircraft landing gear drive wheel to move the aircraft on a ground surface at taxi speeds.

In accordance with the aforesaid objects, a clutch is provided that is designed to effectively transfer torque between wheel drive system components in a vehicle drive wheel drive system and move the vehicle on a ground surface. The wheel drive system components include a non-engine drive means and a roller traction drive or other drive system in torque transmission contact with the clutch and with the vehicle drive wheel. The clutch may include a number of complementarily configured clutch elements designed to mesh into engagement when actuated by an electromagnetic or other engagement means and to produce and amplify circumferential and axial forces that facilitate the transfer of torque to a vehicle wheel. Geometry of meshing components of complementarily configured clutch elements may be selected to amplify the force required after clutch actuation to transmit a desired torque. The clutch elements may disengage when electromagnetic actuation is removed or may remain engaged without operation of the electromagnetic engagement means. Spring elements may bias and maintain the clutch components out of engagement when not activated by the electromagnetic engagement means. A high friction coating may be applied to interfaces between clutch elements and the vehicle wheel. In the presence of selected overspeed parameters, the clutch may be designed to overrun and cease torque transmission. Elements functionally equivalent to a centrifugal brake may be provided to prevent clutch engagement when drive wheel speed exceeds a selected limit. The preferred application of the clutch of the present invention is to control the transfer of torque between a non-engine drive means and a roller traction drive system to drive an aircraft landing gear wheel to move the aircraft during taxi.

Other objects and advantages will be apparent from the following description, drawings, and claims.

### BRIEF DESCRIPTION OF THE DRAWINGS

FIG. 1 illustrates, in partial cross section, a portion of an aircraft landing gear with a single landing gear wheel with a wheel drive system including a non-engine drive means, a roller traction drive system, and a clutch according to the present invention within the dimensions of the aircraft landing gear wheel;

FIG. 2 is a schematic illustration of one embodiment of a clutch in accordance with the present invention useful in controlling torque transfer and transferring torque through a vehicle drive wheel non-engine drive means and a roller traction drive system to drive a vehicle wheel; and

FIG. 3 is a schematic illustration of another embodiment of a clutch in accordance with the present invention useful in controlling torque transfer and transferring torque through a vehicle drive wheel non-engine drive means and a roller traction drive system to drive a vehicle wheel

### DESCRIPTION OF THE INVENTION

Using a non-engine powered drive wheel to drive a vehicle normally driven by an engine on a ground surface can provide significant fuel savings. When the vehicle is an aircraft, the potential savings that accompany moving the aircraft on the ground with drive means other than the aircraft's main engines extend well beyond saving fuel. Efficiently controlling a vehicle drive wheel to move the vehicle requires effectively controlling the transfer of torque through the drive components of the drive wheel drive system. Providing a clutch that is capable of effectively transferring torque and controlling the transfer of torque between a drive means and a roller traction drive or other drive system and a wheel to move the vehicle drive wheel at a desired torque and ground speed has presented challenges. The clutch of the present invention successfully addresses these challenges.

The clutch of the present invention is discussed primarily as it may be used in an aircraft landing gear drive wheel. It is understood, however, that the present clutch design will be useful for controlling torque transmission in any vehicle with a drive wheel driven by a drive means which is a source of power other than the vehicle's main power source in a wheel drive system that includes at least a drive means and a roller traction drive or other drive system for moving the vehicle wheel and, therefore, the vehicle, on a ground surface at a desired torque and speed. The number of drive wheels on a vehicle may vary. For example, without limitation, the clutch design of the present invention may be effectively employed to transmit torque to drive an automobile with one or more electric drive wheel motors in drive wheels that are used to propel the automobile without operation of an internal combustion engine. Other kinds of vehicles and uses are also contemplated to be within the scope of the present invention. Additional applications of the clutch of the present invention in systems other than vehicles are also contemplated.

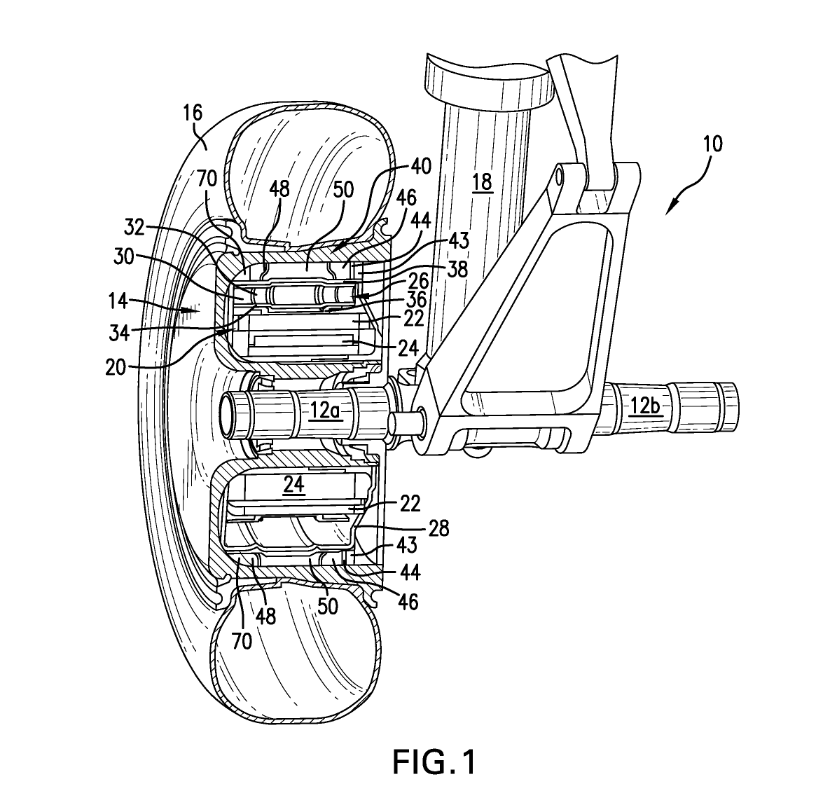

Referring to the drawings, FIG. 1 illustrates, in partial cross section, a drive wheel on an aircraft landing gear 10 rotatably mounted on an axle 12a. The drive wheel 14 may be a nose landing gear or a main landing gear wheel, and a tire 16 is mounted on the wheel 14 as shown. An identical wheel (not shown) would be rotatably mounted on axle 12b. A strut 18 connects the landing gear wheels to the aircraft body (not shown). There may be more than one drive wheel mounted in a nose or main aircraft landing gear. The drive system components, which will be described in detail below, are shown mounted completely within the dimensions of the wheel 14, which is the preferred location for the drive system components, although other locations may also be employed.

In the wheels of a conventional aircraft landing gear, movement of the wheels and, therefore, ground movement of the aircraft are presently controlled by controlling the amount of thrust from the aircraft main engines and applying the aircraft's brakes. In a wheel drive system with the clutch of the present invention, movement of the drive wheel 14 is controlled by the operation of a non-engine drive means 20 that is not powered by the aircraft's main engines, but may be powered by the aircraft's auxiliary power unit (APU) or another suitable source of electric, hydraulic or pneumatic power. In another type of vehicle, for example without limitation, one or more drive wheels may be powered entirely by battery-powered electric motors.

A preferred non-engine drive means 20 may include a rotating element, such as a rotor 22, and a stationary element, such as a stator 24. The rotor 22 may be located externally of the stator 24, as shown, but other drive means component arrangements may also be used. For example, the positions of the rotor 22 and stator 24 could be reversed so that the rotor is internal to the stator.

A drive means 20 preferred for use in a drive wheel drive system with the clutch of the present invention may be an electric motor assembly that is capable of operating at high speed and could be any one of a number of suitable designs. An example of one type of drive means that may be used effectively is an inside-out electric motor in which the rotor can be internal to or external to the stator, such as that shown in FIG. 1 and shown and described in U.S. Patent Application Publication No. 2006/0273686, the disclosure of which is incorporated herein by reference. A range of motor designs capable of high torque operation across a desired speed range that can move an aircraft wheel and function as described herein may also be suitable drive means in the present drive wheel system. A high phase order electric motor of the kind described in, for example, U.S. Pat. Nos. 6,657,334; 6,838,791; 7,116,019; and 7,469,858, the disclosures of the aforementioned patents being incorporated herein by reference, may be effectively used as a drive means 20. The clutch of the present invention may also transmit torque effectively within a drive wheel system using other non-engine drive means, including hydraulic and/or pneumatic drive means.

A wheel drive system in which the clutch of the present invention is designed to function optimally preferably includes a roller traction drive system 26, which is shown only in a location superior to the axle 12a, but, in actuality, extends circumferentially around the wheel axle 12a. The roller traction drive system 26 is not shown in the location it would occupy inferior to the axle 12a so that the wheel drive system housing 28 can be seen more clearly. The roller traction drive system 26 performs essentially the same functions that would be performed by gearing or a gear system. The replacement of gearing by a roller traction drive system in an aircraft drive wheel drive system, or another similar drive system, presents many advantages.

A roller traction drive system designed to actuate a non-engine drive means capable of moving a commercial sized aircraft or other vehicle on the ground not only has a low profile and is light weight, but also provides the high torque and high speed change ratio required to optimally operate the non-engine drive means to move an aircraft on the ground. Unlike a gear system, a roller traction drive system has substantially zero backlash and can be made of dry running components that do not require lubrication. Planetary and other gear systems are capable of only limited gear ratios, while an infinite gear ratio is possible with a preferred roller traction drive system. A roller traction drive system may be, in addition, self-energizing, which requires the maintenance of an optimum coefficient of friction (CF) and traction angle between rollers and a motive surface contacted by the rollers.

One preferred roller traction drive system 26 may employ a series of rollers (not shown), preferably arranged in two rows and positioned within opposed motive surfaces or “races,” for example 30 and 32, so that a respective inner or outer row of rollers contacts an inner or outer race. The roller traction drive system 26 may be positioned within a roller box 34, as shown in FIG. 1. Although balls may be used, rollers have been found to function more efficiently than balls in wheel drive systems described in connection with the vehicle drive wheels described herein. Rollers, particularly hollow cylindrical rollers, do not demonstrate the high levels of friction and/or wear that characterize gears used to drive a motor or other non-engine drive means. In addition, traction and rigidity of a roller traction drive system may be varied as the number of rollers in a roller traction drive is varied, with increased numbers of rollers increasing traction and rigidity.

Ideally, a roller traction drive 26 is designed to achieve the torque and reduction ratios required for optimal operation of a vehicle drive wheel drive system. During high speed operation of the roller traction drive, moreover, the non-engine drive means rotor 22 must be kept in alignment and at a reliably consistent radial distance with respect to the roller traction drive. Additional parameters that maximize the service life and safety of a roller traction drive as it operates in conjunction with a non-engine drive means as described herein to move an aircraft or other vehicle on the ground may also be important considerations in the effective and efficient transfer of torque with the clutch of the present invention. When the roller traction drive system 26 is engaged, torque is transmitted to the drive means 20 through rolling friction, which is approximately equal to the applied torque, although this can be affected by the specific configuration of the roller traction drive system.

A roller box 34 of the roller traction drive system 26 may include a contact element 36 in torque transmitting contact with the rotor element 22 of the non-engine drive means 20. The contact element 36 enables transmission of torque between the roller traction drive system 26 and the drive means rotor element 22 to change the speed of the rotor element as necessary. This arrangement may additionally function as a bearing for the drive means rotor 22. A surface 38 on the opposite side of the roller box 34 from the contact element 36 may be in torque transmitting contact with a clutch, as discussed below.

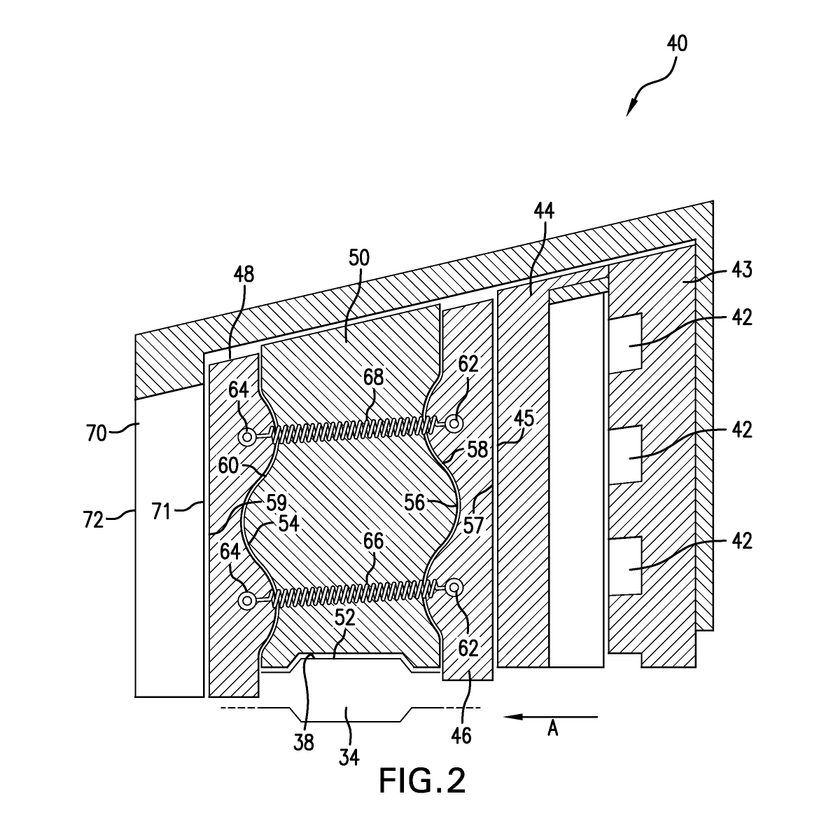

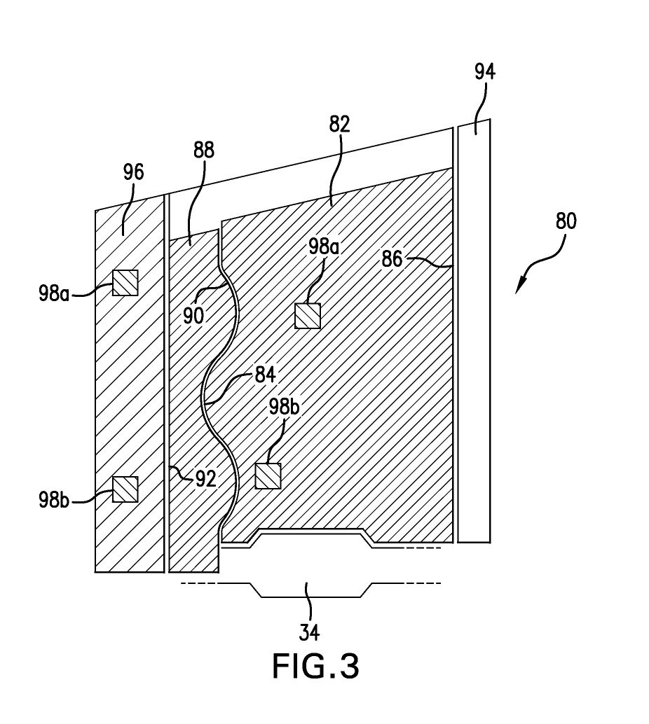

The clutch 40 of the present invention is shown in a preferred location relative to the roller box 34 and non-engine drive means 20 in the aircraft wheel drive system of FIG. 1. FIGS. 2 and 3 present, schematically, the details of the torque transmitting elements and components in two possible embodiments of a clutch in accordance with the present invention. Although these views are essentially two-dimensional, the clutch components shown are, in actuality, ring-like structures located circumferentially and coaxially with a vehicle wheel, as shown within the aircraft drive wheel of FIG. 1, which incorporates the FIG. 2 clutch embodiment. The clutch design of the present invention may include an actuator that may be external to the clutch and clutch elements that may rotate at different speeds and have a complementarily meshing geometric surface configuration brought together by the actuator, as will be described below, so that circumferential force resulting from drag between rotating clutch elements produces an axial force that ultimately transmits torque through the clutch to a drive wheel.

An external actuator of the clutch embodiment shown in FIG. 2 may include an array of electromagnets 42 that are energized, preferably in response to an “Engage Clutch” command, although other actuators are known and may also be used for this purpose. Other arrangements of magnetic elements and/or components may additionally be employed as clutch actuators. For example, without limitation, ring 43 shown supporting the electromagnets 42 in FIG. 2 may also be a single magnetic coil supported in a suitable support ring that extends circumferentially around the wheel 14, as shown in FIG. 1. Such a support ring may also act as a flux former and may direct magnetic flux as required to cause clutch elements to be pulled together as described below. Any other functionally equivalent magnetic actuator arrangement is also contemplated to be within the scope of the present invention. Actuation of the present clutch, moreover, may be produced by any mechanism that causes patterned or toothed clutch elements to drag and a tooth or pattern configuration designed to move meshing clutch elements apart.

In the embodiment shown in FIG. 2, when actuation of the electromagnets 42, or other electromagnetic actuating means causes an engagement ring 44 to be moved axially in the direction indicated by the arrow A. The number of electromagnets used to actuate the clutch of the present invention may vary from that shown and may be determined, for example, by drive wheel drive system size and configuration or by other structurally or operationally relevant considerations. Additionally, the clutch design shown in FIG. 2 may be reversed so that the electromagnets 42, magnetic coil 43, and the engagement ring 44 are located on an opposite axial extent of the clutch 40 so that when the electromagnets 42 or magnetic coil 43 are energized, the engagement ring 44 moves axially in a direction opposite to that of arrow A. The electromagnets 42 may also be in different locations from that shown, provided that, in this location, they cause the engagement ring 44 to be pushed into contact with a clutch component or clutch components to be pulled together as described herein to cause the clutch to engage.

A clutch capable of effectively transmitting torque as described herein may have a range of different configurations and may include different numbers of clutch elements. For example, without limitation, the clutch 40 shown in the clutch embodiment of FIG. 2 may include three main components: a first clutch element 46 and a second clutch element 48, each positioned axially to engage an opposed radial edge of a central clutch element 50. These three clutch elements are preferably made of rigid materials and may be made of any materials capable of functioning effectively in a vehicle wheel environment. Other numbers and/or configurations of clutch elements are described below and are also contemplated to be within the scope of the present invention. The first and second clutch elements 46 and 48 in this embodiment are functionally equivalent.

The central clutch element 50 in this embodiment may be mechanically linked to the roller traction drive system roller box 34, preferably along roller box surface 38 by a flexible coupling (not shown) that provides moderate play to the clutch. Other suitable connections may also be employed. The central clutch element 50 has a surface 52 that is correspondingly configured to engage surface 38 of the roller box 34.

The opposed edges 54 and 56 of the central clutch element 50 may additionally be formed with a geometric pattern, such as the contoured or toothed pattern shown in FIG. 2. The edge 58 of the first clutch element 46 adjacent to the edge 56 of the central clutch element 50 and the edge 60 of the second clutch element adjacent to the edge 54 of the central clutch element 50 may be formed in a pattern that is the corresponding reverse of that on the central clutch element opposed edges. When the clutch elements are fully engaged as described herein, the patterned or contoured opposed edges 56 and 54 of the central clutch element will then mesh with each respective edge 58 and 60 of the first and second clutch elements 46 and 48. Any meshing or toothed pattern that will accomplish this result may be used on the respective mating edges of the three clutch elements 46, 48, and 50. For example, without limitation, meshing clutch elements could also be formed with a complementary spiral toothed design or another functionally effective design on meshing edges. The patterned toothed designs on the clutch elements form part of the mechanical input of the clutch.

The respective axial edges 57 and 59 of first and second clutch elements 46 and 48 that do not have geometric patterns may form contact surfaces with other clutch and/or wheel structures. Consequently, the edge surfaces 57 and 59 optimally have a shape that allows the clutch elements 46 and 48 to rotate freely relative to adjacent structures, such as a surface 45 on the engagement ring 44 or a surface 71 on a wheel interface ring 70, and/or each other, as described below. The clutch elements 46 and 48 may be conical, curved, or have any other suitable symmetry that allows them to rotate freely relative to the wheel axle 12a when not engaged so that the vehicle wheel can also spin freely. The surfaces 57 and 59 may also be slightly uneven, provided that they are sufficiently smooth to avoid contact with adjacent surfaces during rotation. A surface 72 on the wheel interface ring 70 opposite surface or edge 71 may contact the wheel 14 (FIG. 1) when the clutch is engaged.

A high friction coating material, such as, for example without limitation, a diamond coating or a coating of a material with frictional properties equivalent to diamond, may be applied to contact surface 59 on the second clutch element 48 and/or on the surfaces 71 and 72 of the wheel interface ring 70. Such coatings are known in the art.

The clutch of the present invention may be designed to be coaxial with a non-engine drive means 20 and a roller traction drive system 26 and mounted radially outwardly of these drive system components completely within a vehicle wheel as shown in FIG. 1. The clutch elements 46, 48, and 50, engagement ring 44, and interface ring 70 are configured to rotate with the other wheel drive system structures as the wheel is driven to rotate about the axle 12a.

A number of spring elements, such as the springs 66 and 68 shown in FIG. 2, may be provided at selected circumferential locations to link the first and second clutch elements 46 and 48 and to bias the second clutch element so that the patterned edge 54 is held out of meshing engagement with the complementarily patterned edge 60 of the central clutch element 50. The first clutch element 46 may be positioned in meshing engagement with the central clutch element 50 as shown, or the second clutch element 48 may be positioned in meshing engagement with the central clutch element 50. Spring fasteners 62 and 64 may be provided on the first and second clutch elements to secure the respective ends of the spring elements 66 and 68. The spring elements 66 and 68 should be sufficiently strong to hold the clutch elements 48 and 50 out of engagement until an “Engage Clutch” command is instituted. The number of spring elements that may be required for this purpose will depend, in part, on the size and specific configuration of the vehicle wheel drive system. The design of the toothed or other pattern on the meshing edge surfaces of the clutch elements may have a specific configuration, such as, for example, a slope, that keeps these clutch element surfaces separated so that friction surfaces of the clutch elements may be engaged. Other functionally equivalent structures may also be employed for this purpose.

In an additional embodiment 80 of the clutch of the present invention, shown schematically in FIG. 3, the design is simplified so that one of the first or second clutch opposed elements is eliminated, leaving a first clutch element 82, which is coupled to a roller box 34 and has a single patterned edge 84 and a smooth edge 86. A second clutch element 88 has a complementarily patterned meshing edge 90 axially adjacent to the first clutch patterned edge 84 so that these surfaces will mesh and engage when the clutch is commanded to engage. Smooth edge 86 on the first clutch element 82 and smooth edge 92 on the second clutch element 88 may contact, respectively, an actuated clutch engagement element 94 and a wheel interface element 96. In this embodiment, springs are not needed to move the clutch elements into and out of engagement. The geometry of the toothed or other meshing surface pattern may be adapted for this purpose.

A different design of electromagnetic engagement means is employed in the FIG. 3 embodiment than the electromagnets used with the FIG. 2 embodiment. This electromagnetic engagement means may pull the clutch elements toward each other to cause them to engage, rather than pushing them axially to overcome a force holding them apart. One or both of a clutch output element, such as the wheel interface ring 96, and a clutch element, such as clutch element 82, may be made of steel. One or both of these clutch elements may be provided with an optimum number electromagnets, such as electromagnets 98a and 98b, located to cause the clutch elements to be pulled together into meshing engagement. The electromagnets 98a may be spaced so that they do not align axially on clutch element 82 and interface ring 96, but are offset as shown in FIG. 3. Alternatively, the magnets 98b may be positioned to align axially on the clutch element 82 and on the wheel interface ring 96. Other positions and combinations of electromagnets that will pull the clutch elements 82 and 88 into engagement with each other and into contact with the wheel interface ring 96 when the electromagnets are actuated may also be used and are contemplated to be within the scope of the present invention.

In operation, the clutch of the present invention may require an external actuator which brings together two rotating clutch elements that may be rotating at different speeds, thereby creating drag. Angled surfaces, for example, teeth, on patterned edges or surfaces of the rotating clutch elements are caused to interact by this drag so that the angled surfaces transform circumferential force caused by the drag into axial force, which pushes the rotating clutch elements securely together, thereby locking the clutch. Additionally, when an “Engage Clutch” command has been received by the clutch in the wheel drive system described herein, the electromagnets 42 or 98 are energized. An “Engage Clutch” command may be instituted manually or, preferably, automatically when wheel drive system sensors and/or software determine that the control of torque transfer provided by the clutch is required during operation of the wheel drive system. A variety of actuation systems for clutches actuated by electromagnetic energization means are available and could be incorporated into a vehicle wheel drive system that uses the clutch of the present invention.

In the FIG. 2 embodiment, energization of the electromagnets 42 causes the engagement ring 44 to move axially in the direction of the arrow A so that the planar edge 45 of the engagement ring comes into contact with the planar edge 57 of the first clutch element 46 and applies a force in the direction of arrow A to the first clutch element 46. This axial force applied to the first clutch element 46 overcomes the biasing force of the springs 66 and 68 and causes the clutch elements 46, 48 and 50 to move from a position in which the clutch elements are out of engagement into a position in which they are fully engaged. In the fully engaged position, the contoured edge 58 of the first clutch element 46 meshes with the correspondingly contoured edge 56 of the central clutch element 50, and the opposed contoured edge 54 of the central clutch element 50 meshes with the correspondingly contoured edge 60 of the second clutch element 48. The meshed engagement of the three clutch elements causes the planar edge 59 of the second clutch component to contact the planar edge 71 of the wheel interface ring 70. In turn, the edge 72 of the wheel interface ring contacts the vehicle wheel (FIG. 1). The coefficient of friction between the clutch elements and the vehicle wheel may be used to transmit torque.

Once the clutch 40 is engaged, frictional forces may enable the clutch elements 46, 48 and 50 to remain engaged without assistance from the electromagnets 42. De-energization of the electromagnets 42 may be used to disengage the clutch so that the engagement ring 44 moves out of contact with the clutch elements and the springs 66 and 68 bias and maintain the clutch elements out of meshing contact with each other and, thus in a disengaged condition. In an overspeed condition, which may be detected with respect to established operating parameters, the clutch is intended to overrun so that torque transmission is stopped.

In the FIG. 3 embodiment, energization of the electromagnets 98 causes the clutch element 82 to be pulled into meshing contact with the clutch element 88 and with the wheel interface ring 96 so that torque is transmitted to a vehicle wheel, such as wheel 14 in FIG. 1.

In both the FIG. 2 and FIG. 3 embodiments, prior to actuation of the electromagnets and activation of the clutch, all of the clutch elements are rotating at the same speed, and an output ring, here represented by the wheel interface rings 70 and 96, maybe rotating at a different speed. Activation of the electromagnets or other like system causes one of the patterned or toothed clutch elements 48 or 88 to move axially and push against and contact a respective wheel interface ring 70 or 96, thereby creating friction. This friction causes the contacting clutch element to rotate at a different speed than the adjacent meshing clutch element, which, in turn, causes sloped surfaces of the clutch element teeth to come into contact. Because teeth surfaces are preferably sloped, circumferential force produced by the resultant drag creates additional axial force, which increases friction. Amplification of this axial force as described eventually produces enough friction to lock the input, the roller box 34 and the clutch element coupled to the roller box, and the output, here the wheel interface ring, thereby fully engaging the clutch. When the clutch element teeth have a spiral configuration, additional control of axial force versus drag force results from the necessary axial movement as one clutch element rotates at a different speed from an adjacent meshing clutch element with spiral teeth.

Torque transmission can be controlled by controlling the kinds of friction surfaces used in the present clutch and by selecting an optimum clutch element tooth slope angle. This enables the clutch to be designed so that a relatively weak magnetic actuation force is amplified to a force level sufficient to transmit a desired torque. If it is desired for the clutch not to be self-energizing, these parameters may be adjusted so that the clutch will release as soon as electromagnetic actuation is stopped, which could be done automatically in response to selected conditions or manually.

The clutch of the present invention may be designed for bi-directional engagement, primarily when the wheel drive system is moving in reverse. A suitable force, such as that described above with respect to the movement of engagement ring 44, may be applied to the edge 59 of the second clutch element 48 or to the edge 57 of the first clutch element 46 to move the clutch elements 46, 48 and 50 into meshing engagement to transmit torque between wheel drive system components and the vehicle wheel. For torque to be applied by the present clutch in both directions, the arrangement of clutch elements in FIG. 2 is preferred to ensure that drag on adjacent clutch elements will be in the desired direction.

Although not specifically shown, clutch elements, such as those in FIG. 2, could be formed with teeth on radial surfaces so that engagement forces are supplied entirely by a control system without the force amplification described above. The engagement system would be required to pull the clutch elements in a radial direction to cause meshing engagement of toothed surfaces. A benefit of such a radial arrangement may be enhanced control of overspeed. In an overspeed situation, release of the clutch may be caused by a natural pull against control of the clutch by the overspeed.

To enhance safe operation of the wheel drive system, the clutch of either the FIG. 2 or the FIG. 3 embodiment may incorporate structural features designed to mechanically prevent engagement of clutch elements when a vehicle wheel or other rotating structures in a wheel drive system, such as that described herein, exceed a determined speed. As an example, without limitation, pins, dowels, or the like (not shown) may be provided on one of the clutch element or engagement plate surfaces that may lock into a corresponding groove when the predetermined speed is exceeded. Such structures function like centrifugal brakes to mechanically prevent clutch engagement. In addition, the clutch may be designed to operate as a drive means or motor brake during reverse motion of a wheel drive system.

While the present invention has been described with respect to preferred embodiments, this is not intended to be limiting, and other orientations, arrangements and structures that perform the required functions are contemplated to be within the scope of the present invention.

### INDUSTRIAL APPLICABILITY

The clutch design of the present invention will find its primary applicability where is desired to provide effective torque transfer and control over torque transfer in a wheel drive system that includes a non-engine drive means and a roller traction drive system within the dimensions of a vehicle wheel and is designed to move the vehicle wheel to move the vehicle on a ground surface at a desired speed and torque. A preferred use of the present clutch design is to transfer and control torque within a wheel drive system in an aircraft landing gear wheel operated by the wheel drive system to move the aircraft on the ground at taxi speeds.

1. A vehicle drive wheel drive system comprising, mounted within a vehicle drive wheel, a non-engine drive means, a roller traction drive system, and a clutch in torque transmitting contact with said non-engine drive means, said roller traction drive system, and said vehicle drive wheel, wherein said clutch comprises a selected number of coaxial meshing clutch elements held out of meshing engagement and positioned in torque transmitting contact between said roller traction drive system and a vehicle drive wheel, and further comprises actuation means external to said clutch adapted to generate an axial force sufficient to urge said clutch elements into meshing torque transfer contact with said roller traction drive system and said vehicle drive wheel.

2. The system of claim 1, wherein said selected number of coaxial meshing clutch elements comprises a central clutch element with opposed first and second patterned edges, a first clutch element with a complementarily patterned edge adjacent to said central clutch element first patterned edge, and a second clutch element with a complementarily patterned edge adjacent to said central clutch element second patterned edge, wherein said central clutch element opposed first and second patterned edges and the complementarily patterned edges of said first clutch element and said second clutch element are formed with a corresponding meshing contoured pattern so that said central clutch element forms a unitary structure with said first clutch element and said second clutch element when said first and second clutch elements and said central clutch element are urged into meshing torque transfer contact.

3. The system of claim 2, wherein each of said first clutch element and said second clutch element has an unpatterned edge axially opposite said complementarily patterned edge, and wherein the unpatterned surface on said first clutch element is positioned to be in force transmitting contact with said actuation means and the unpatterned surface on said second clutch element is positioned to be in torque transmitting contact with an interface with a vehicle drive wheel.

4. The system of claim 3, wherein said central clutch element further comprises a roller traction drive-contacting edge extending between said opposed patterned edges and coupling means between said central clutch element and said roller traction drive whereby torque is transferred through said clutch and said unpatterned edge on said second clutch element to a vehicle wheel.

5. The system of claim 3, further comprising a layer of a high friction material comprising a coating of diamond or a material with friction characteristics of diamond on the unpatterned edge of said second clutch element and on an edge of an interface with said vehicle drive wheel.

6. The system of claim 1, wherein said selected number of coaxial meshing clutch elements comprises a first clutch element with a patterned edge and an opposed unpatterned edge, and a second clutch element with a complementarily patterned edge adjacent to and designed to mesh with said first clutch element patterned edge and an opposed unpatterned edge, wherein said first clutch element patterned edge and said second clutch element complementarily patterned edge are formed with a corresponding meshing contoured pattern so that said first and second clutch elements form a unitary structure when said first and second clutch elements are urged into meshing toque transfer contact.

7. The system of claim 6, further comprising a wheel interface ring positioned in torque transfer contact between said second clutch element unpatterned edge and said vehicle drive wheel.

8. The system of claim 7, wherein said actuation means comprises a selected number of paired electromagnets positioned on said second clutch element and on said wheel interface ring at selected spaced locations spaced so that each one of the electromagnets in a pair is aligned or is offset and not aligned.

9. The system of claim 2, further comprising a plurality of spring elements positioned circumferentially on said clutch connected to said first clutch element and to said second clutch element to bias said first clutch element and said second clutch element out of meshing engagement with said central clutch element until said actuation means is activated to engage said clutch.

10. The system of claim 1, wherein said actuation means comprises a selected number of automatically or manually actuatable electromagnets.

11. The system of claim 1, wherein said vehicle comprises an automobile and said vehicle drive wheel comprises one or more of the vehicle's front or rear wheels.

12. The system of claim 1, wherein said vehicle comprises an aircraft and said vehicle drive wheel comprises one or more nose landing gear wheels or one or more main landing gear wheels.

13. The system of claim 1, wherein said non-engine drive means comprises an electric motor capable of producing torque required to drive the vehicle.

14. A clutch comprising clutch elements designed to effectively transmit torque between components of a vehicle drive wheel drive system comprising at least non-engine drive means and a roller traction drive system and a vehicle drive wheel when said vehicle wheel is driven in a forward or in a reverse direction, wherein said clutch elements are configured for axial meshing engagement in response to a clutch activation and engagement force sufficient to overcome a force holding said clutch elements out of axial meshing engagement, and one of said clutch elements is in torque transfer contact with said roller traction drive system and with another of said clutch elements, and said another of said clutch elements is in torque transfer contact with a vehicle drive wheel.

15. The clutch of claim 14, wherein said vehicle comprises an aircraft, said non-engine drive means comprises an electric motor with a rotor positioned outwardly of a stator, and said vehicle drive wheel comprises one or more nose landing gear wheels or one or more main landing gear wheels.

16. A method for transferring torque through an aircraft nose or main landing gear drive wheel drive system to a nose or main drive wheel to drive the aircraft at a desired torque or speed on a ground surface, comprising:
a. providing an aircraft drive wheel drive system for one or more nose or main landing gear drive wheels, said drive system comprising at least a non-engine drive means, a roller traction drive in torque transfer contact between the drive means and a drive wheel;
b. providing a clutch comprising a selected number of meshing torque-transferring clutch elements configured for meshing engagement in torque transfer contact with the roller traction drive and the drive wheel, wherein said clutch elements are maintained out of meshing engagement;
c. engaging the clutch by activating an external actuation means to move a clutch element in force transferring contact with said actuation means with sufficient force to overcome force holding said clutch elements out of meshing engagement, thereby forcing said clutch elements into meshing engagement and into torque transfer contact with said roller traction drive and said drive wheel; and
d. transferring torque from said drive means through said roller traction drive to said drive wheel and driving said drive wheel to drive said aircraft at a desired taxi speed or torque.

17. The method of claim 16, further comprising providing adjacent meshing surfaces on said clutch elements having a configuration designed to cause amplification of forces produced when said clutch elements are actuated, thereby locking said clutch.

18. The method of claim 17, further comprising providing actuation means comprising a selected number of electromagnets and actuating the electromagnets in response to an “Engage Clutch” command to move said clutch elements into meshing torque transfer contact.
